(19) United States
(12) Patent Application Publication
(10) Pub. No.: US 2008/0092824 A1
(43) Pub. Date: Apr. 24, 2008

(54) Aquarium bubbler where bubbles represent smoke

(76) Inventor: Gerald Levin, Northbrook, IL (US)

Correspondence Address: PIONEER PATENT, LLC, P. O. BOX 128, NORTHBROOK, IL, 60065-0128, US

(21) Appl. No.: 11/585,580

(22) Filed: Oct. 24, 2006

(51) Int. Cl. A01K 63/00

(52) U.S. Cl. 119/253

(57) ABSTRACT

The present invention provides an aerating aquarium ornament wherein the air bubbles simulate smoke. An ornament may be a scale model of a fire, smokestack, chimney where a cavity beneath the fire, smokestack, tailpipe or chimney having an interior cavity that accommodates an air hose terminus. When bubbles are released from the air hose terminus, the bubbles escape from the fire, smokestack, tailpipe or chimney to simulate smoke.

### BACKGROUND OF THE INVENTION

Fish are often kept as pets and for aesthetic pleasure. Typically, fish in the water do better with some air circulation through the water, so many aquariums are equipped with aerator hoses, which typically pass through airstones and the like to create bubbles that rise up through the water.

Several aquarium ornaments have been introduced that incorporate bubblers. For example, paddle wheels incorporated in immersed aquarium sculptures spin as bubbles released below the paddle wheel rise up and cause the paddle wheel to rotate. Several decades ago, “Diver Dan” style deep sea diver ornaments moved due to air bubbling into the ornament. Penn Plax, Inc. (Hauppapauge, N.Y.) today makes many ACTION-AIR™ aquarium ornaments, where the rising bubbles cause motion in the resin ornaments. Examples include opening clams, treasure chests, and barrels, sometimes with pop-up figures, moving dinosaurs, shipwrecks and divers. Penn Plax, Inc. also makes sharks, alligators and dragons whose mouths open due to rising bubbles.

In recent years, miniature scenes with simulated rivers appear to flow due to bubbles rising under a clear river “surface”, often releasing the bubbles from the stream in position to power the paddle wheel of the miniature mill. Also with this new technology, “waterfalls” have been crafted, with similar clear covering over the “waterfall” behind which bubbles rise to provide an illusion of waterfall movement.

The present invention provides a new class of aerating ornaments, where the rising bubbles simulate smoke. Although a great many underwater ruins, miniature houses, and castles have been made for aquarium use, none of them utilized flowing bubbles to give an illusion of smoke from a chimney, smokestack, tailpipe or fire.

U.S. Pat. No. 5,165,778 Aquarium Lighting System discloses an LED aquarium lighting system. In one embodiment, they teach a decoratively lit volcano for use in an aquarium where the volcano preferably includes a gas discharge means that permits buoyantly rising bubbles to escape the volcano opening to have the appearance of smoke and/or erupting materials coming from the volcano, preferably with intermittent bursts to more closely resemble an erupting volcano.

A primary objective of the present invention is to provide a means for an artistic depiction of smoke underwater.

An advantage of the present invention is the provision of aeration to an aquarium while also providing aesthetic enhancement.

A further benefit of the present invention is to permit an animated depiction of a campfire in an aquarium.

A further advantage of the present invention is to permit an animated depiction of a smoking chimney in an aquarium.

A still additional benefit of the present invention is to permit an animated depiction of a smokestack in an aquarium.

Other objects and features of the present invention will be obvious to those skilled in the art, upon contemplation of the disclosure herein in connection with the accompanying drawings. It is to be understood, however, that the drawings are designed for the purpose of illustration only and not as a definition of the instant invention, for which reference should be made to the claims appended hereto.

### SUMMARY OF THE INVENTION

The present invention provides an aerating aquarium ornament wherein the gas bubbles simulate smoke. Embodiments include scale models of a fire, smokestack, tailpipe or chimney. The air bubbles released through holes in the fire, smokestack, tailpipe or chimney rise through the cavity to escape from the fire, smokestack or chimney and simulate smoke. The gas is introduced through a tube, the terminus of the tube releases bubbles that pass through the holes in the fire, smokestack, tailpipe or chimney by (i) being released into an internal cavity within the bubbler, cavity exits including the holes; (ii) release of the bubbles in close proximity to and preferably beneath the holes; or connection of the gas dispersing means directly to the at least one hole. When the bubbler has an internal cavity, the portion cavity through which bubbles must pass preferably has generally upward-sloping sides and an opening to accommodate an air hose terminus from which air bubbles are released. The air hose terminus is optionally fitted with an air diffuser (e.g. an airstone or other gas dispersing means) to provide more numerous bubbles.

In an embodiment, the ornament is a scale model of a fire, for example a campfire or a fire in a fireplace. A fireplace embodiment may also include a chimney element through which the bubbles depicting smoke pass to escape from the ornament. In an example of an animated embodiment of a fireplace, the legs of Santa coming down the chimney raise and drop in the air bubble stream. In an example of an animated embodiment of a campfire, food cooking over the fire moves due to the passing air bubbles. In another example of an animated embodiment of a campfire, hands warming over the campfire raise and lower in the stream of rising air bubbles.

In an alternative embodiment, the ornament includes a scale model of a chimney, but a “fire” is not visible. Rather, the chimney is a portion of a building and the bubbles depicting smoke rise from the chimney. Examples of this embodiment include houses and cabins as aquarium decoration.

In an embodiment, the aerating aquarium ornament includes a scale model of a smokestack from which air bubbles escape simulating smoke. In some embodiments, the smokestack is an exhaust from a machine. Such a smokestack is typically part of a scale model of a machine, for example a train. Also contemplated is simulated smoke escaping from a machine, such as a tailpipe of an automotive vehicle or airplane. In some embodiments, a smokestack is an exhaust from a building, for example a factory.

### DESCRIPTION OF THE DRAWINGS

In the drawings forming a portion of the disclosure of the invention:

FIG. 1 is a front elevational view of an aerating aquarium ornament of the invention shaped like a miniature scale outdoor scene with a woodcutter warming his hands beside a fire. As shown, depicted in use in an environment of a water-filled aquarium, bubbles escape from the replica fire, when bubbles pass through the replica logs from a gas/air feeding into an aeration source positioned beneath. The bubbles of gas/air buoyantly rising to the aquarium water surface from the fire are shown in the drawings, where the bubbles suggest smoke when the aquarium bubbler is in use.

FIG. 2 is a front elevational view of an aerating aquarium ornament of the invention shaped like a model house with a chimney, where the bubbles rising from the replica chimney suggest smoke.

FIG. 3 is a front elevational view of an aerating aquarium ornament of the invention shaped like a model log cabin with a chimney, where the bubbles rising from the replica chimney suggest smoke.

FIG. 4 are side elevational views of a replica train locomotive engine with a smokestack; A showing a train having 4 wheels and B showing a train having 3 wheels. As shown, depicted in use in an environment of a water-filled aquarium, bubbles escape from the train smokestack, when the smokestack funnels bubbles from an air/oxygen feeding into an aerator hose. The air/oxygen escaping to the aquarium water surface are shown in the drawings from the train smokestack through which air/oxygen passes when the aquarium bubbler is in use.

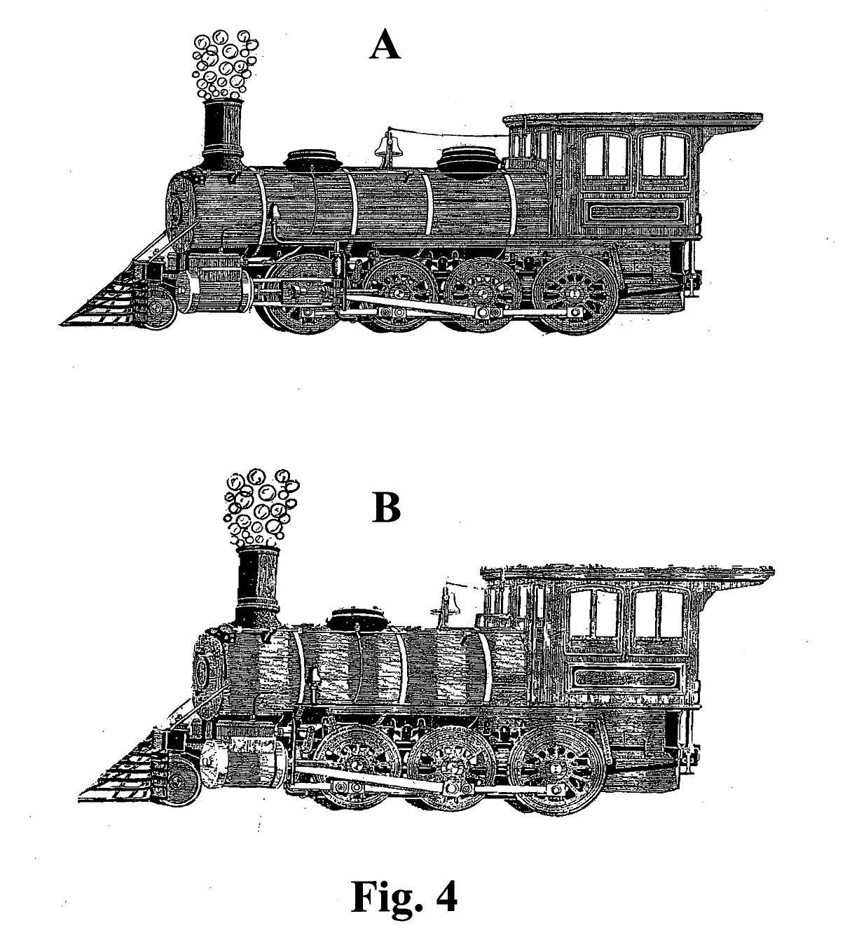

### DETAILED DESCRIPTION OF THE INVENTION

The present invention contemplates an aerating aquarium ornament wherein bubbles simulate smoke when gas is flowing through the ornament in the liquid environment of an aquarium tank. In a basic embodiment, an aeration hose feeds gas (typically air) into or beneath the ornament. The ornament provides an opening or a plurality of openings that may include but is not limited to a diffuser through which the air passes and breaks up into bubbles. The released bubbles rise up through the aquarium water, simulating smoke.

In an embodiment of the present invention, the aquarium ornament includes a portion visually simulating a fire, as in a fireplace or campfire. Such an embodiment typically provides a visible depiction of burning wood or coals. The released bubbles arise through an opening or openings in or behind the burning wood or coals so as to give the appearance of smoke rising from the fire. In this embodiment, the bubbles optionally further pass through a model chimney, and up to the water surface.

In a fireplace embodiment, the aquarium ornament may depict a cozy home scene, for example, with a domestic in-home fireplace, optionally with a portion of the walls surrounding the fireplace. This embodiment optionally contemplates the depiction of other household furniture and figures, for example, a hearth with a dog curled up in front of the fire, and a cozy chair with elements suggesting a fireside activity such as eyeglasses and a book or sewing. In another fireplace embodiment, the aquarium ornament depicts a Christmas scene, with additional elements suggesting Christmas decorations or common figures, such as Santa Clause coming down the chimney, a Christmas tree, Christmas stockings hung along the fireplace mantle.

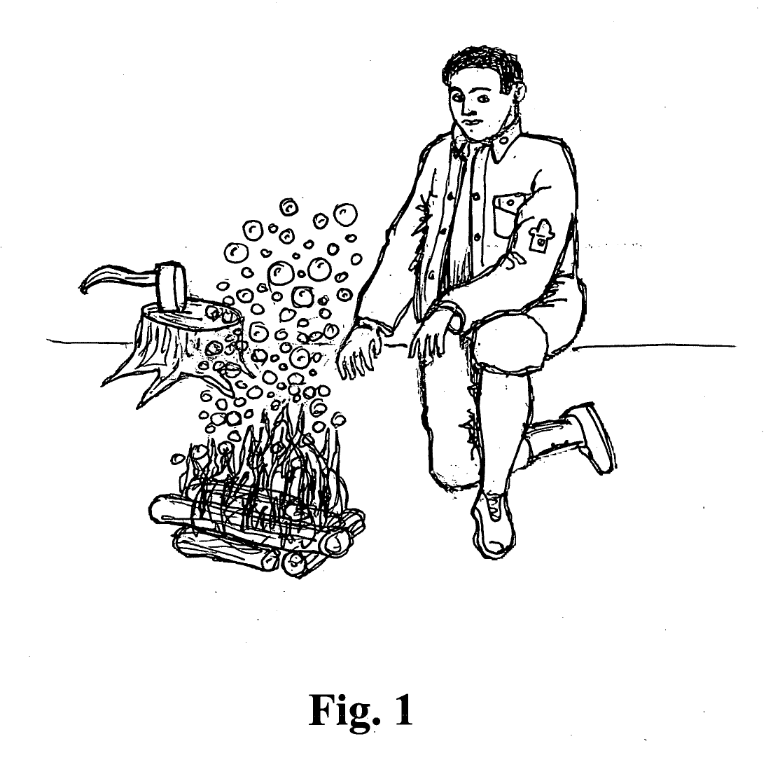

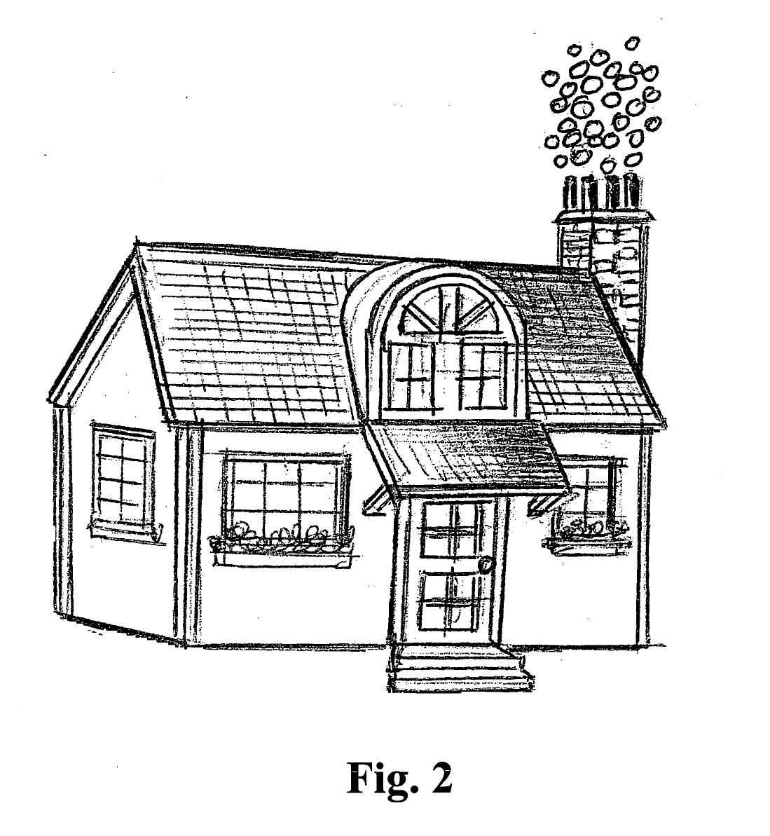

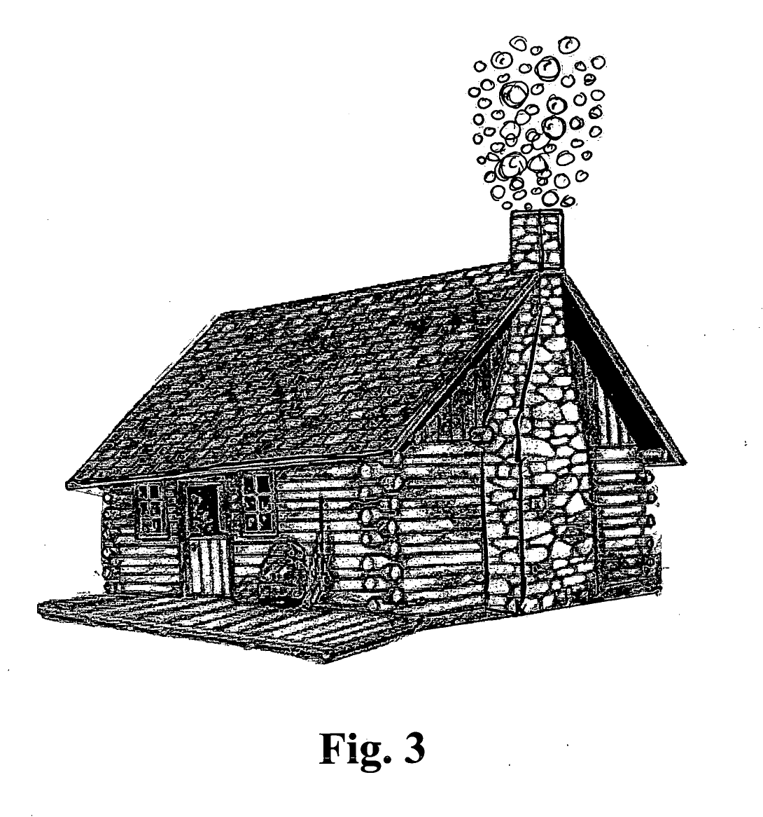

In an embodiment that includes a chimney, the aquarium ornament is shaped like a building. An example shown in FIG. 1 where the building is a house or cabin. The ornament is formed such that bubbles escape from the building chimney. The ornament is contemplated for use in the environment of a water-filled aquarium with air/oxygen feeding into an aerator hose. The air/oxygen escaping to the aquarium water surface are shown in the drawings from the building chimney through which air/oxygen passes when the aquarium bubbler is in use. A building with a chimney is the essential portion of this embodiment of the present invention, where a wide variety of architectural details of the building are contemplated. FIG. 2 shows a building that is a house and FIG. 3 shows a cabin.

In a campfire embodiment, an example of which is shown in FIG. 1, the smoke appears to rise up from the campfire. Being a scale model of a campfire, traditional scenes incorporating a campfire are contemplated, such as hobos around a campfire, cowboys resting around a campfire, or scouts camping around a campfire. The figures could be interacting with the fire, such as cooking over the fire, warming hands over the fire.

In an embodiment of the present invention where scale models of houses, buildings, automotive vehicles, trains, airplanes, fireplaces, and campfires are depicted, a variety of ornamental structural and artistic details are contemplated. For example, details could be used to distinguish various replica models of existing, full-sized items. Alternatively, entirely fanciful “scale models” could be depicted not based on an existing or previously-made item. Also contemplated are a variety of figures and detail items. Figures and details include for example, passengers or freight on the train; figures and animals around a campfire; household items around a fireplace. Examples of contemplated figures include people in period costume or characters (including non-human, and known characters).

It should be appreciated that there a wide variety of conventional materials that may be used to form a claimed aquarium bubbler. The present invention contemplates the use of an aquarium sculpture material of the art. The following examples of materials are illustrative and non-limiting. For many years, ceramic was the material of choice for aquarium sculptures that do not leach chemicals into the water that may endanger the health of the fish kept in the aquarium. More common today are cast poly-resin products. Resin cast construction permits ease in manufacturing of a wide range of sculptures with gross to fine details and a wide variety of colors affordably. Alternatively, an aquarium sculpture may be carved out of a material, as opposed to cast.

A contemplated aquarium ornament may be sold with or without an aeration hose or diffuser. In some embodiments, the ornament has an opening underneath that will accommodate an aeration hose terminus that optionally has an air diffusing means (for example, and airstone). The ornament itself, however, only has an interior cavity that communicates to the ornament exterior via a hole through which gas bubbles may pass. The at least one hole would be in the ornament wall at a site as needed for a chimney, smokestack, tailpipe or fire.

In some embodiments, the introduction of the aeration source is distant from the hole to the ornament exterior from which “smoke” would emanate. In such a construction, the interior cavity of the ornament through which the bubbles would pass has the hole to the ornament exterior generally above the aeration source. Preferably the walls of the interior cavity are generally sloping upward, in a manner that would funnel the bubbles up to the hole(s) from which “smoke” would emanate.

In an alternative embodiment, a contemplated aquarium ornament has a built-in diffuser close to and preferably beneath the hole or holes through which “smoke” would emanate. In such an embodiment, the aeration source (e.g. air hose) would be connected directly and preferably securely to the diffuser.

It should be appreciated that conventional air pumps, tubing, hoses and diffusers are contemplated for use with and in the present invention, and that the examples given herein are merely illustrative.

The invention contemplates having an animatable element that falls within the theme of the scale model of a fire, smokestack or chimney that is activated by the passing air bubbles as they simulate smoke.

For example of an animatable element, an embodiment with Santa Claus coming down the chimney into a fireplace has a small, lightweight plastic depiction of Santa's telltale, red-clad legs and boots positioned within the channel of the chimney such that air bubbles depicted smoke gather under the Santa portion and cause it to rise up when the gather bubbles provide sufficient lift. The rising movement of the Santa portion permits passage of the bubbles through the chimney, so that Santa falls back down again toward the fire. The animated effect is Santa reacting to landing on a hot fire—ouch!

As another example of an animatable element, an embodiment with a campfire has a small, lightweight plastic depiction of food being cooked over the fire. In this example, a roasting fork is positioned on a fulcrum (for example the fulcrum is positioned in a human figure's hand). The food end of the roasting fork is positioned within the air bubble flow so that the food rises and falls above the fire with the passage of the air bubbles.

In an alternative example of an animatable element depicting cooking food, meat could be roasting on a spit over the fire, where the meat has a shape (acting as baffles) such that bubbles rising as “smoke” from the fire will cause the meat to rotate “on the spit” over the fire.

As another example of an animatable element, an embodiment with a campfire has a small, lightweight plastic depiction of hands being warmed over a fire. In this example, the arms of the hands are positioned on a fulcrum (for example the fulcrum is positioned at the elbow or shoulder of a human figure). The hands are positioned within the air bubble flow so that the hands rise and fall above the fire with the passage of the air bubbles.

Although only a few embodiments of the present invention have been described herein, it should be understood that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope of the appended claims.

What is claimed is:

1. An aerating aquarium ornament comprising a scale model of a fire, smokestack, tailpipe or chimney wherein the ornament has one or more openings at the fire, smokestack, tailpipe or chimney through which bubbles are emitted thereby simulating smoke.

2. The aerating aquarium ornament according to claim 1 wherein said ornament has an interior cavity, and wherein one or more openings pass through to the ornament interior cavity, wherein said interior cavity has a separate interior opening that accommodates an air hose terminus to release bubbles into the interior cavity such that air bubbles released from the air hose pass into the interior cavity through the opening at the fire, smokestack, tailpipe or chimney to escape from the fire, smokestack or chimney thereby simulating smoke.

3. The aerating aquarium ornament according to claim 1 wherein said air hose terminus is fitted with an air diffuser.

4. The aerating aquarium ornament according to claim 1 wherein said ornament is a scale model of a fire.

5. The aerating aquarium ornament according to claim 4 wherein said ornament is a scale model of a fire in a fireplace.

6. The aerating aquarium ornament according to claim 4 wherein said ornament is a scale model of a fire in a campfire.

7. The aerating aquarium ornament according to claim 1 wherein said ornament is a scale model of a chimney.

8. The aerating aquarium ornament according to claim 7 wherein said scale model of a chimney comprises a portion of a scale model of a building.

9. The aerating aquarium ornament according to claim 8 wherein said building is a house.

10. The aerating aquarium ornament according to claim 1 wherein the ornament is a scale model of a smokestack.

11. The aerating aquarium ornament according to claim 10 wherein said scale model of a smokestack comprises a portion of a scale model of a train.

12. The aerating aquarium ornament according to claim 10 wherein said scale model of a smokestack comprises a portion of a scale model of a building.

13. The aerating aquarium ornament according to claim 5 further comprising a scale model of a chimney above the fireplace, wherein said chimney comprises a channel through which air bubbles appearing to rise from the fire in the fireplace pass to escape from the ornament.

14. The aerating aquarium ornament according to claim 13 further comprising a lightweight scale model of a human figure positioned within the channel of the chimney, such that the rising bubbles cause the human figure to be lifted and to drop within the channel of the chimney.

15. The aerating aquarium ornament according to claim 4 further comprising a raising element on a fulcrum positioned with the raising element above the fire and the fulcrum to the side of the fire to permit the passage of air bubbles to raise the raising element.

16. The aerating aquarium ornament according to claim 15 wherein said raising element depicts food cooking on a roasting fork over the fire.

17. The aerating aquarium ornament according to claim 15 wherein said raising element depicts hands being warmed over the fire.

18. The aerating aquarium ornament according to claim 1 wherein said tailpipe comprises a portion of a scale model of an automotive vehicle.

19. The aerating aquarium ornament according to claim 1 wherein said tailpipe comprises a portion of a scale model of an airplane.
